(19) United States
(12) Patent Application Publication
(10) Pub. No.: US 2004/0267962 A1
(43) Pub. Date: Dec. 30, 2004

(54) Method and system in wireless data communication network for transferring content to terminal equipment and corresponding terminal equipment, server and browser devices

(75) Inventor: Petri Ahonen, Jyvaskyla (FI)

Correspondence Address: HARRINGTON & SMITH, LLP, 4 RESEARCH DRIVE, SHELTON, CT, 06484-6212, US

(73) Assignee: NOKIA CORPORATION

(21) Appl. No.: 10/606,174

(22) Filed: Jun. 24, 2003

(51) Int. Cl. G06F 15/16

(52) U.S. Cl. 709/246

(57) ABSTRACT

The invention concerns a method in a wireless data communication network for transferring content to terminal equipment, in which method content arranged for a server located in the data communication network is transferred as data transfer through the data communication network to the terminal equipment for browsing in a browser session and wherein at least a part of the content is associated with at least one special identifier, which is used to indicate the special character of the content in question to manage it in the established manner. In the method, at least a part of the said content provided with an identifier is transferred to the terminal equipment as background processing essentially without affecting the data transfer of the terminal equipment's browser session proper.

### FIELD OF THE INVENTION

The invention concerns a method in a wireless data communication network for transferring content to terminal equipment, in which method the content arranged for a server in the data communication network is transferred as data transfer through the data communication network to the terminal equipment for browsing in a browsing session and wherein at least a part of the content is associated with at least one special identifier, which is used to indicate the special character of the concerned content in order to control it in the established manner. Besides the method, the invention also concerns a corresponding system, terminal equipment, server and browser equipment.

### BACKGROUND OF THE INVENTION

Many mobile phones known today have such a browser application arranged therein, which can be used for presenting, for example, files in ML, that is, markup language, on the display of the terminal equipment. Such files may contain resource data of different kinds, besides the mere body text. Such resource data can be said to include, although in this case or even from here on in no limiting manner, for example, picture elements, drawings, icons, borders, audio data or other content data and applications generally processed or interpreted by terminal equipment. Files in markup language can be fetched in accordance with the known technology from a server arranged in the data communication network and arranged to provide browsable content to terminal equipment, which content downloaded from the server can then be presented to the user with the browser of the terminal equipment.

In the case of the present-day browser applications, the state of the art is represented, for example, by such a procedure, where the browser of the terminal equipment is used to send downloading requests to the server arranged in the data communication network in order to download content in the terminal equipment. The server responds to the downloading requests by gathering together the content identified in the requests and sending it by way of response to the terminal equipment. The terminal equipment then receives the content data, and the browser application is possibly used to parse the content into a form that can be presented on the terminal equipment display.

As one example of such markup language possibly requiring parsing XML or extensible Markup Language may be mentioned, as modes of presentation based on this language are nowadays in widespread use in the presentation of content. XML is known as a kind of meta language, which can be used for defining structural markup languages.

Nowadays the use of the so-called cache memory function is also known in connection with browser applications of terminal equipment. The cache memory provides the browser of the terminal equipment with a data buffer, wherein it is possible for their later smooth browsing to store markup language files and/or related resource content transferred already at an earlier stage from the data communication network to the terminal equipment in connection with the browsing. Some browsers also allow using pages arranged locally in the cache memory or so-called bookmark pages as the starting page of browsing. In some solutions, the starting page may have to be fetched each time when starting the browsing, possibly even all the way from the server arranged in the network.

For some quarters operating in data communication networks it has nowadays become necessary to provide terminal equipment users, for example, with special browsing starting pages or so-called portals, which are downloaded in the terminal equipment display in connection with the starting of the browser. Some, although in no way limiting, examples of such quarters are operators, service/content providers and terminal equipment manufacturers. It is known that it is desired to make such presentation of starting pages as striking and pleasant as possible for the user, which requires input in its visual appearance. Hereby even a specific special stylesheet file may be used on the pages, which function may be fulfilled, for example, by a game or generally any application used for controlling the overall appearance of page presentation. In such an exactly defined outlining form, which may include various resources, such as graphic elements, borders, logotypes etc., even interactive applications, special fields or data areas are arranged for information in text form, into which the pure text is then adapted.

It is known that in low bit rate data transfer channels it is very difficult or even impossible to provide an interaction quality of a browser session acceptable to the users, in such services in particular, which instead of or along with the pure text contain plenty of resource files, which are bigger than pure text as regards their file size.

The known basic technology especially for such low bit rate browsing is represented by various standards, of which the WML description language may be mentioned as an example. Using these it is possible to create separate sets of pages/services explicitly for low bit rate use instead of the normal Internet use.

In addition to those mentioned above, some more advanced ways are also known of providing browsers with cache functions. Wo publication 03/030026 (Symbian Limited) makes known a way wherein a special flag can be set for chosen content to indicate the permanent character given to the content in the terminal equipment's cache. The permanent character is obvious, for example, when the terminal equipment's cache is emptied to get free memory capacity. However, also in this solution the procedure of downloading content having a special identifier into the terminal equipment is carried out in a manner known as such, that is, data transfer takes place independently of the character/type of the content. Here the terminal equipment directs to the server a request of a kind known as such for downloading of the content, to which downloading request the server then responds by gathering together and sending the requested content independently of its special character through the data communication network to the terminal equipment essentially in connection with the actual browser session. A part of the said content may now include such content intended for essentially permanent storing in the cache, which content may be shown to the user with the browser, for example, when the user is beyond the reach of the data communication network.

However, a solution of the kind described above is not able to answer the requirements made by, for example, the operating quarters mentioned above, such as operators, service providers, terminal equipment manufacturers or other such quarters, for example, in the updating of content provided with such a flag. A requirement for updatability of such content is made, for example, by the circumstance that operators like to provide such a browser with their default-value style file, which has to be updated at least at some stage. Even active presentation to users of, for example, content relating to services on offer is difficult according to the known technology, because transfer of content to the terminal equipment is managed at the terminal equipment end according to the known technology. Furthermore, besides the above, the solution presented in the WO publication hardly improves at all the usability of low bit rate browsing.

### Summary of the Invention

The purpose of this invention is to bring about a method in a wireless data communication network for transferring content to terminal equipment. The characteristic features of the method according to the invention are presented in the appended claim 1. Besides the foregoing, it is a purpose of the invention also to bring about a corresponding system, terminal equipment and server, whose characteristic features are presented in the appended claims 15, 20 and 22. In addition, the invention also concerns browser equipment, the characteristic features of which are presented in claim 23.

In the method according to the invention, at least a part of the content to be transferred or already transferred to the terminal equipment is provided with a special identifier indicating the manageability of the content. At least a part of the content provided with such an identifier is transferred to the terminal equipment as background processing. Such background processing is characterized, for example, by not having any essential influence on the data transfer of the terminal equipment's actual browser session.

In the method according to the invention, a static cache functionality is arranged in the established manner at the terminal equipment, where the arranged content provided with a special identifier can be managed in a very flexible manner. This management can be said to include, for example, contentrelated updating steps, which according to one embodiment can be updated both by updating steps taken from the terminal equipment or it can even be made independently of the terminal equipment, for example, from the data communication network.

The method offers a possibility to several different quarters and agents of managing content to be stored at and transferred to the terminal equipment. With the method a way becomes possible for parties operating in the mobile communication network or generally otherwise closely related to it, such as, for example, terminal equipment manufacturers, of managing content transferred or transferable to the terminal equipment besides the management done by the terminal equipment or by its user or even entirely independently of these.

Any party may establish the content identifier indicating the special character. Content provided with the identifier is not deleted from being in connection with the terminal equipment's memory devices, for example, in connection with conventional management steps to be taken with the memory.

According to the method, the content and services brought to the terminal equipment for browsing, which may be, for example, recommended by some quarter operating or exerting an influence in the data communication network, function better in many different ways than those corresponding services and implementations, which do not use the method according to the invention.

An example of improvement achieved with the method according to the invention is the essentially improved user interaction quality, for example, in low bit rate data transfer. Hereby browsing of content and use of services, which have resources of which at least a part may be arranged in connection with a static resource partition formed in the terminal equipment's memory devices, can be speeded up to such a user interaction quality level, which is nowadays known, for example, from text-based services. Some more additional examples of improvements that can be achieved hereby are, among others, smaller interaction delays, essentially quicker content downloading actions and lower data transfer costs.

The terminal equipment and server according to the invention, which together with the data communication network constitute the system according to the invention, include functionalities for management and updating of such content provided with a special identifier even entirely independently of the user's actions. The terminal equipment, where the browser equipment according to the invention are arranged, may according to one embodiment include a functionality analysing the browsing, based on which content can be transferred to the terminal equipment even in advance. This can even be done without being fully certain that the user will browse the concerned content downloaded in advance.

Other characteristic features of the method, system, terminal equipment, server and browser equipment according to the invention, will emerge from the appended claims, and more advantages to be achieved are listed in the specification part.

### BRIEF DESCRIPTION OF THE DRAWINGS

In the following the invention, which is not limited to the embodiments to be presented, will be described in greater detail by referring to the appended drawings, wherein

FIG. 1 is a rough schematic view of the system according to the invention, of the terminal equipment's functionalities and of the browser equipment, and

FIGS. 2-3 are rough flow diagram presentations of an example of the method according to the invention.

### DETAILED DESCRIPTION OF THE INVENTION

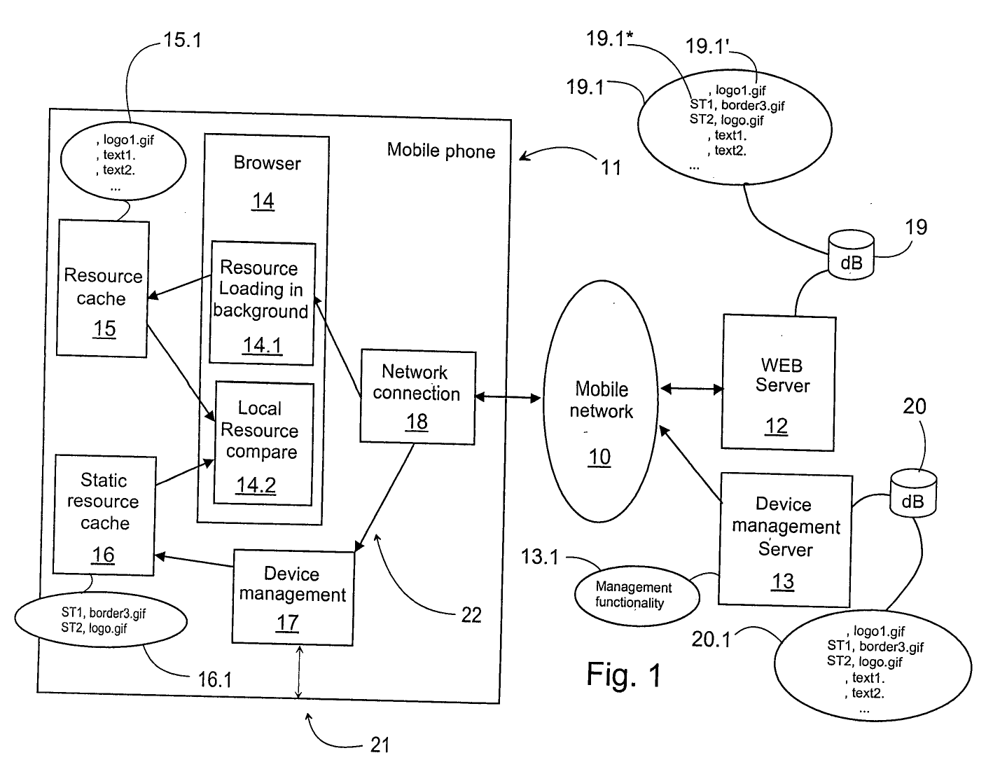

FIG. 1 shows an example of the system implementing the method according to the invention in a wireless data communication network, more specifically in this case (however, in no way by limitation) in mobile communication network 10 and operators 11-13 possibly operating therein and functionalities arranged in connection with them. Besides the fact that the method according to the invention provides the terminal equipment 11 user with a more advanced way of getting content for browsing at his terminal equipment 11, the method also provides other parties 12, 13 operating in or closely related to data communication network 10 with an advanced way of transferrin content to terminal equipment 11 even fully without the user's knowledge or without the user being otherwise disturbed. As such other parties 12, 13 operating in mobile communication network 10 or as parties on a par with these, mobile telephone operators, service and content providers generally and mobile telephone manufacturers can be mentioned as examples.

Transfer of content 19.1 to terminal equipment 11 can also be understood very largely. Firstly, it can be understood as downloading steps to be performed starting from terminal equipment 11 as well as from some functionality arranged in data communication network 10, such as, for example, data transfer arranged as starting from server 12, 13 towards terminal equipment 11. Thus, according to the state of the art, that is, besides a data transfer procedure started on terminal equipment's 11 initiative, the party starting the data transfer may also be, for example, server 12, 13.

Data communication network 10 includes at least one server 12, for which content 19.1 is arranged that can be transferred to terminal equipment 11. Also “content” can now be understood very largely. It may include data intended generally for browsing or listening at terminal equipment 11, such as, for example, text, various resources, such as, for example, graphic elements, such as, for example, icons, drawings, pictures, borders or audio, such as, for example, voices or music 19.1*, 19.1′. In addition, content 19.1 can be said also to include data that can be used in the formatting of resource data and in placing it on the broswer's 14 display, which cannot as such be directly browsed on the display, but which allows, among other things, setting of the above-mentioned resources 19.1 on the terminal equipment's 11 display in the established manner.

Furthermore, content can also be understood as application data and as a program code that can also generally be performed at terminal equipment 11. According to the method of the invention, applications and service entities transferred to terminal equipment 11 may be, for example, interactive. Games can be mentioned as an example of applications.

A part of the content 19.1 to be transferred to terminal equipment 11, which content may be arranged in data communication network 10 in connection with the memory equipment 19 of one or more servers 12, may be provided with at least one special identifier ST1. The identifier ST1 of this kind is used to indicate the special character established for the content 19.1* in question and relating to its management at terminal equipment 11. The content 19.1* provided with identifier ST1 can be managed, such as, for example, stored, kept or updated, for example, after transfer to terminal equipment 11 in accordance with the established criterion.

There may be numerous such above-mentioned criteria. As a first example of these may be mentioned the keeping of the content in terminal equipment's 11 cache 15, 16 even after cache 15, 16 has been emptied, for example, in order to free storing space. Establishing an identifier ST1 for the content 19.1 is technology obvious to the professional in the field and it may be done, for example, in the heading data of the content or in any corresponding meta data field.

Data communication network 10 also includes, for example, a management functionality 13.1 arranged for server 12 set to provide content 19.1 or arranged for server 13 arranged entirely separately from server 12 set to provide content for management of the content 20.1 set to be provided to terminal equipment 11 or already stored and provided with a special identifier ST1. Server 13 may be, for example, under the management of a mobile phone operator, who uses the method according to the inventio in order to provide content 19.1* to terminal equipment 11.

In the method according to the invention, the data communication network 10 may also be understood very largely. It may consist of one or more similar or different networks arranged in connection with one another. In most cases, the servers 12, 13 arranged to provide content and services 19.1 are on the Internet, which means that data transfer can at some stage also take place under Internet management. However, the last data transfer link before terminal equipment 11 is usually a wireless mobile phone network 10, wherein numerous network connection modes are in use, as is known. Some of these modes, such as, for example, low bit rate data transfer channels, benefit significantly from using the method according to the invention, thus improving, among other things, the quality of browser user interaction.

For the server 13 including management functionality 13.1 information 20.1 may at least be arranged about those pieces of terminal equipment 11, which are within the sphere of influence of the method according to the invention. In addition, server 13 may also have other information relating, for example, to the static content 19.1* arranged or to be arranged for each terminal equipment 11 and to the updating events of the static content 19.1*, such as, for example, the version information of content 19.1* with each terminal equipment 11. The content 19.1* may thus differ between the individual pieces of terminal equipment.

Besides one or more servers 12, 13, data communication network 10 includes at least one piece of terminal equipment 11 of a kind known as such and equipped with browser application 14, which terminal equipment also includes, among other things, network connection protocols 18 allowing the browser function. Using the terminal equipment's 11 browser application 14 it is possible for the user in a way known as such to address downloading requests to the server 12 providing content, concerning the content 19.1 set to be provided to itself. In connection with terminal equipment 11 cache devices 15, 16 of a kind known as such are also arranged, where that content and content resources 15.1, 16.1 can be stored, which are transferred to it from server 12. Such a resource buffer may be used by browser application 14 instead of or along with downloading of resources from network 10. The resource buffer may in its known parts be implemented as a corresponding kind of cache index, which is known, for example, from PC browsers, where WEB page resources can be stored in the computer's memory devices.

The resource buffer of terminal equipment 11 includes a special static resource partition 16, wherein the said content 16.1 provided with a special identifier ST1 is stored in accordance with the established criterion. The static resource partition 16, which may essentially be located in the same storing medium with the actual resource cache 15, can often be formatted in different ways. For the formatting procedure the terminal equipment 11 may have a specific data transfer interface 21, which is arranged, for example, in connection with management functionality 17 to be described later. As some, although in no way limiting, examples of these ways of formatting that formatting may be mentioned by way of example, which is performed at the stage of manufacture of terminal equipment 11, or that, which is performed in connection with the maintenance of terminal equipment 11. Another formatting possibility could be such, that the user of terminal equipment 11 performs the formatting himself, for example, in connection with the software updating or by activating, for example, a formatting application implemented on the SIM (Subscriber Identity Module) card using SAT (Sim Application Toolkit) technology, with which the formatting is then performed in data communication network 10.

In the formatting, such content data 19.1*, for example, may be transferred to terminal equipment 11, which includes resources given priority by, for example, the equipment manufacturer, by some mobile phone operator in general, by a target operator subsidizing a batch of terminal equipment or by service and content providers, for example, in connection with the services or content 16.1 they provide. Such may be, for example, provision of software which can be run at terminal equipment 11 or a special membership club provided by the manufacturer for the users of terminal equipment 11. Such a local resource reserve 16.1 may thus include, for example, an assortment of graphic or service elements.

The browser application 14 according to the invention includes a functionality 14.2 for connecting locally arranged resources 15.1, 16.1 with resources 19.1 to be downloaded from server 12. At least some information relating to the WEB page using the resource can hereby be embedded in the local resource heading or name, where browser 14 may safely find out the suitability of the resource 16.1* provided with identifier ST1 in each browsing situation.

In addition, in the case of an embodiment to be described later, terminal equipment 11 may also have functionalities 14.1, 17 for downloading of content 19.1 in advance and also generally for transferring it to terminal equipment 11, for example, in another data transfer connection simultaneously with the browser session proper.

In addition, terminal equipment 11 includes a functionality 17 for management of content 16.1 provided with a special identifier ST1. A functionality of a corresponding type may also be included in a server 13 set to manage content 19.1* provided with a special identifier ST1, which may be used alternatively for management of actions relating to the concerned special content 19.1*, such as, for example, its transfer and updating to terminal equipment 11. However, in this case, it may become necessary to request the consent of the terminal equipment 11 user, because the data transfer can then be performed even so that the terminal equipment 11 user party is entirely unaware of the transfer.

Thus, in the method according to the invention, at least a part of the content 19.1* provided with a special identifier ST1 is transferred to terminal equipment 11 as background processing. This means that the data transfer of content 19.1* taking place as background performance will not essentially affect the data transfer of any actual browser session taking place at terminal equipment 11 at the same time.

According to one embodiment, such data transfer performed as background processing may be performed essentially separately from the data transfer of the browser session proper. The resource data transfer to take place to terminal equipment 11 may take place, for example, by way of normal browser protocols. On the other hand, the data transfer may also be carried out using some non-browser protocol. The own channel located in terminal equipment 11 for transferring content 19.1* provided with the special identifier ST1 separately from the browser session proper is indicated by reference 22 schematically in FIG. 1. Here channel 22 runs from the data transfer interface 18 of terminal equipment 11 through device management 17 to the static resource cache 16. The data transfer may be performed, for example, by using a different PDP context at the data transfer session. The PDP context is packet data transfer technology known as such, for example, in connection with GPRS (General Packet Radio System) data transfer, so there is no reason for describing it in greater detail in this connection.

When using the PDP context and when the data communication network supports an IP based system, the IP address of terminal equipment 11 can be set in an active server mode, in consequence of which terminal equipment 11 will be able to identify updating requests of servers 12, 13 arriving from data communication network 10.

According to another embodiment, background processing may mean that a special QoS (Quality of Service) is requested of data communication network 10 for the said data transfer to be performed as background processing.

According to a third embodiment, data transfer sessions may also be given priority in the desired order. Hereby, if terminal equipment 11 is used to perform at the same time with the ordinary web browsing also data transfer of content 19.1* provided with a special identifier ST1 to terminal equipment 11, priority is given to web browsing of the actual ordinary content 19.1′ without an identifier to a higher level and transfer of the content 19.1* provided with a special identifier ST1 to terminal equipment 11 to a lower level (secondary/primary context). At such a time when ordinary web browsing is not performed, the transfer to terminal equipment 11 of content 19.1* having a special character may be performed as background processing at a higher priority level, depending in part on the duties hereby to be performed with terminal equipment 11.

The content 19.1* provided with a special identifier ST1 and to be transferred to terminal equipment 11 may also be encrypted and/or compressed. Hereby the sender 12 and recipient 11 of the content have devices (not shown) for processing of the data thus processed.

As has emerged also in the foregoing, transfer to terminal equipment 11 of the content 19.1* provided with a special identifier ST1 may be managed even by several different parties. To this end, there may be several identifiers ST1, ST2, etc. instead of one. This can be used to indicate, for example, management steps to be taken with different contents 19.1* and/or the licence procedure relating to their management. According to one embodiment, management may be performed by a functionality arranged in connection with data communication network 10, such as, for example, the abovementioned device management server 13. Different identifiers may be used to identify, for example, an unambiguous management server 13 or even an unambiguous licence procedure licenced to manage the concerned content 19.1*. Terminal equipment 11 may thus have content 19.1* that can be managed subordinated to several management servers 13. When some of these servers 13 observes, for example, updatings in content 19.1* provided with a special identifier ST1, a data transfer connection can be activated for the chosen one or more pieces of terminal equipment 11 and updating of content 19.1* may be performed (for example, as a push service).

According to another embodiment, transfer to terminal equipment 11 of content 19.1* provided with identifier ST2 can also be managed by terminal equipment 11 or also by its user. At terminal equipment 11 a management functionality 17 for special content 19.1* can be set to observe the content's 19.1* need for updating. Management functionality 17 can hereby send an inquiry concerning the need for updating steps made in content 19.1*, for example, to server 13 arranged in data communication network 10 to manage content 19.1*. It is of course also possible to make a request for a check directly to server 12 providing content 19.1*.

According to a third embodiment, such an identifier ST3 may be set, with which performance of updatings is permissible in the stamped content, for example, only using the maintenance tools of terminal equipment 11.

For example, in order to activate the management functionality 13.1, 17 to be activated in connection with updating of terminal equipment's 11 cache 15, 16, there are several alternatives. It can be activated, for example, by the user, by terminal equipment 11 or by network 10. One criterion for triggering the updating function could be its thresholding to take place, for example, when service elements provided with a special identifier have changed in accordance with a condition established for them. Hereby, when performing an updating session as background processing separately from the web browsing session proper, for example, in another PDP context, the user will not be caused any trouble in the actual web browsing which may be performed at the same time.

Content provided with a special identifier ST1 can be chosen in several ways. According to one embodiment, a limit value is established for the file size of content 19.1* provided with a special identifier ST1, whereby any exceeding file size is seen as belonging to such content to be transferred to terminal equipment 11 according to the method of the invention. In addition, such resources may be characterised in that when using low bit rate ways of data transfer they form bottlenecks to smooth browsing. Usually resource content understood as such is content already largely described above, such as, for example, graphic elements, pictures, music and other such resoruce data, depending, for example, on the settings and classifications made by the user or by other parties. Another example which may be mentioned of such content is the starting page used in browsing and services set as active ones, which are recommended for use by the user at each time for some reason.

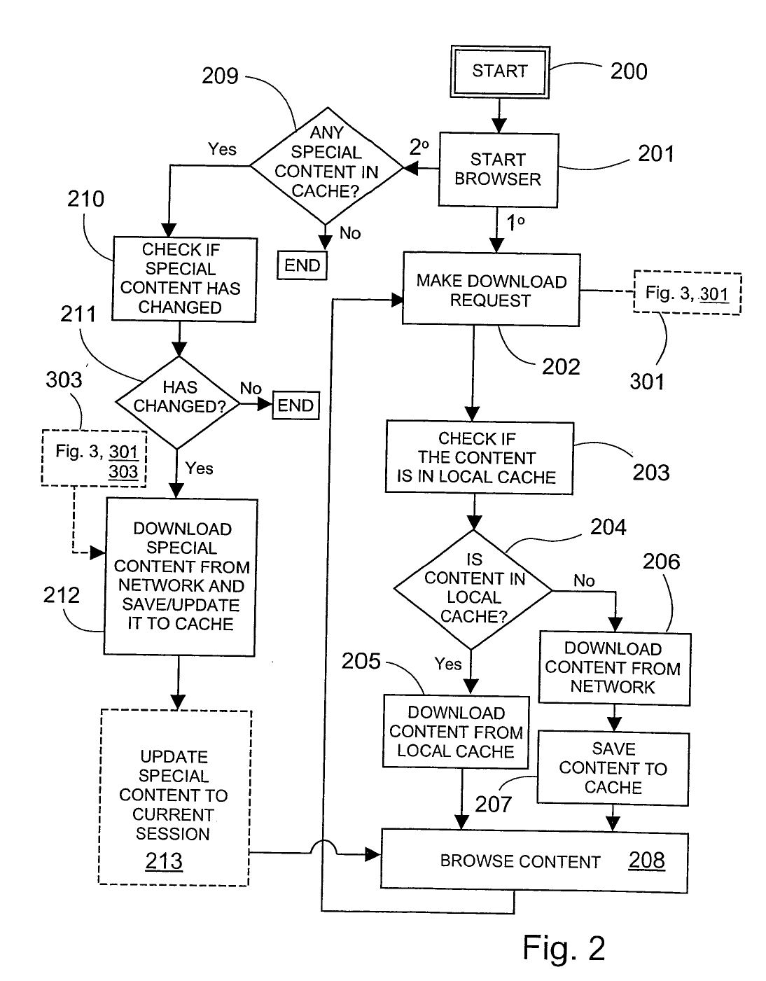

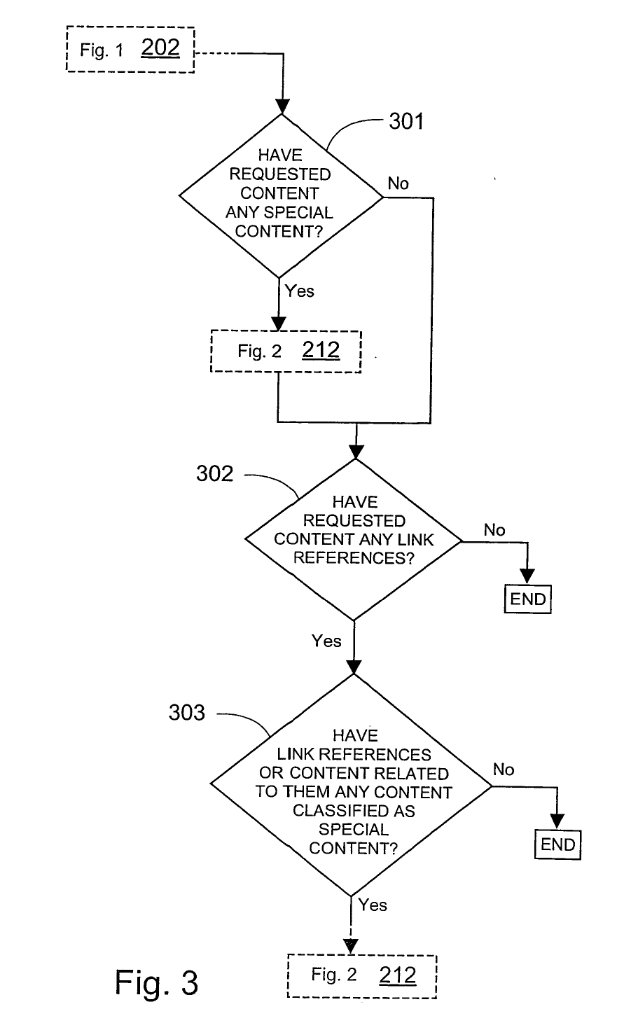

FIGS. 2-3 are flow diagram presentations of an application example of the method according to the invention. It should be noted that this is only an individual application example, whereby the method according to the invention can be implemented also as several different sub-stage alternatives.

In FIG. 2, the user of terminal equipment 11 first starts browser 14 and may use it to make an ordinary downloading request to server 12 arranged in data communication network 10 to provide content 12 (200-202). Next, browser 14 may carry out a check to find out whether the content, which the downloading request concerned, is already stored in browser's 14 cache 15, 16 (203). Depending on the settings of browser 14, the content can be fetched to browser 14 from resource cache 15, if it is there already, and, for example, a time stamp established for it can be filled, which stamp is used to control the freshness of the content (204-205). On the other hand, if the content 15.1 is not found in the resource cache 15 of terminal equipment 11 or if its time stamp does not fulfill the condition established for it, the downloading request concerning it is done to server 13 arranged in the data communication network (204-206).

Server 12 receives in a manner known as such the downloading request concerning content 19.1, gathers a content 19.1 corresponding with it from its memory devices 19 and sends it to terminal equipment 11 in response to the downloading request (206). Terminal equipment 11 receives content 19.1, brings it in its browser 14 to the display in a suitable form and may in an established manner store content 19.1 in the resource cache of terminal equipment 11 (207).

The above was a lengthy presentation of state-of-the-art routine steps in browsing performed with terminal equipment 11 (route 1°, 201). According to the method of the invention, it is possible, for example, in sub-step 201 also to activate the management functionality 17 arranged in terminal equipment 11 for content 16.1* provided with a special identifier ST1 (route 2°, 201)

According to one embodiment, activation of equipment management functionality 17 need not necessarily be related in any way, for example, to browsing to be started or already being performed at terminal equipment 11, but routine branch 2° can be started also when the established criterion is fulfilled, entirely independently of the actual browsing performed or not performed by the user. Such a criterion may be, for example, the time of day, when data communication network 10 is in light use in terms of its transfer capacity (for example, in the night). Another example of a criterion could be triggering coming from data communication network 10 for activation of the function (for example, from server 13). A third criterion may be generally related to an established period of time, which has passed since the previous updating occasion.

In routine branch 2° shown in FIG. 2, a check can first be made of whether any such special content 19.1* is arranged in terminal equipment 11 at the present time or whether there is even any intention to store such content there. If on the concerned starting occasion the situation is such that no content 19.1* is established as existing at terminal equipment 11, then management functionality 17 can be finished right away (209).

On the other hand, if such content 16.1 is already arranged in terminal equipment 11 or if the terminal equipment 11 is set in general to hold such content 16.1*, 19.1*, then a check can be made next to find out whether any changes have arrived in such content 16.1*, such as, for example, updatings, for example, after the previous browsing occasion (209-211). The check can be made, for example, from server 12, 13, using some suitable call. If no updating has arrived, then the performance of flow diagram branch 2° can be finished.

If updatings have arrived at least in a part of content 16.1*, then the concerned updated content 19.1* is downloaded from server 12 as background performance in the manner already described as such above. Background performance is characterised in that it does not essentially affect the actual browsing carried out by the user. In principle, the user does not even necessarily know that such an updating measure in background processing is taking place, because it can be carried out, for example, in a packet context entirely separately from the actual browsing session (212).

As the special content 16.1 is being updated, each content presented by browser 14 may of course be updated correspondingly in relevant parts (213). Browsing (208) is performed in accordance with action steps known as such, wherein, for example, when clicking a link reference fitted into the content, a return again takes place in the flow diagram to the step where the downloading request is made (202).

FIG. 3 shows another embodiment relating to the method according to the invention. When making a downloading request concerning content 19.1 in FIG. 2, at stage 202, browser 14 or a management functionality 17 arranged in connection with the browser may be used to move over to such a performance branch, where a check is made to find out whether in the content 19.1 which the downloading request concerns there is any content 19.1* provided with a special identifier ST1 19.1*, or generally some link references and/or of what kind are the contents of the content 19.1 relating to this downloading request or the contents relating to the link references therein (301-303).

A check can first be made of whether in the requested content there is any content 19.1* provided with a special identifier ST1 (301). If such is included in the content defined in the downloading request, then the process moves on to stage 212 shown in the flow diagram in FIG. 2, wherein such a content 19.1* is downloaded into a static resource reserve 16 arranged in the cache of terminal equipment 11, and the action is updated by terminal equipment 11. Here and also in case the downloading request contained no content 19.1* provided with a special identifier ST1, a check can be made to find out whether if in the content to be transferred based on the downloading request there are any link references further to other pages (302). If references are found, the content relating to these pages can be checked and more especially whether they include any content 19.1* provided with a special identifier ST1(303).

If such content 19.1* provided with a special identifier ST1 is found on some web page, it may be transferred to cache 15, 16 arranged in terminal equipment 11 in a new and surprising way even in advance. In this case, too, the downloading is done as a background performance, for example, with a second simultaneous data transfer session. Advance downloading of resources 19.1* can now be done even in the case that there is no full certainty that the user will during the browsing session move over to the concerned page to browse the content arranged there.

Guidance in advance downloading of resources may be given, for example, by programming of the WEB page. Hereby, for example, the header of the WEB page may contain a field for indicating the content 19.1* provided with a special identifier ST1, which relates to the concerned page. When the user then browses the page, downloading may take place at the same time as background performance of resources 19.1* relating to any page to be browsed next into terminal equipment's 11 resource cache 16. When the user then possibly continues his browsing by going to this next web page, at least a part of its resources 19.1* is already ready at terminal equipment 11. Thus, according to the user's experience of browsing, downloading of the following pages will take place much more quickly and the browsing is more pleasant also in other respects. Downloading of mere text data relating to the web page may be carried out, for example, in the actual browser connection and at that stage only, when the user makes a downloading request concerning the concerned page. Due to its small file size, downloading of pure text data is essentially no bottleneck to smooth browsing.

Thanks to the invention the programmer of WEB service may utilise some public resource library for the resources 19.1* of all web pages. Hereby the downloading of resources 19.1* relating to the pages is performed essentially mainly at one time as background processing, in consequence of which browsing is very quick in the concerned WEB service. This resource bank″ of the WEB server, from which the browser 14 supporting the method according to the invention may download resources, can be identified in some special way on the original WEB page.

For example, the SIM card or various memory cards, such as, for example, the MMC card, can be mentioned as other examples of delivering content 19.1* carrying a special identifier ST1 to terminal equipment 11.

It should be understood that the foregoing description and the pictures relating to it are only intended to illustrate the present invention. Thus, the invention is not limited only to the embodiments presented above or defined in the claims, but many such different variations and modifications of the invention will be obvious to the professional in the field, which are possible within the scope of the inventive idea defined in the appended claims.

What is claimed is:

1. Method in a wireless data communication network (10) for transferring content (19.1) to terminal equipment (11), in which method content (19.1) arranged for a server (12) located in the data communication network (10) is transferred as data transfer through the data communication network (10) to the terminal equipment (11) for browsing in a browser session, and wherein at least a part of the content (19.1*) is associated with at least one special identifier (ST1), used for indicating the special character of the content (19.1*) in question in order to manage it in an established manner, characterised in that at least a part of the said content (19.1*) provided with identifier (ST1) is transferred to the terminal equipment (11) as background processing essentially without affecting the data transfer of the terminal equipment's (11) browser session proper.

2. Method according to claim 1, characterised in that the data transfer performed as background processing takes place essentially in its own connection context in such a way that it is carried out over a channel (22) of its own and separately from the data transfer proper of the browser session.

3. Method according to claim 1 or 2, characterised in that there are two or more of the said identifiers (ST1, ST2), which identifiers (ST1, ST2) are used for indicating, for example, management steps to be taken with the content (19.1*) and/or a licence procedure pertaining to their management.

4. Method according to claim 2, characterised in that the said content (19.1*) provided with an identifier (ST1, ST2) is transferred to the terminal equipment (11) by a functionality (12, 13) arranged in the data communication network (10).

5. Method according to claim 2, characterised in that the said content (19.1*) provided with an identifier (ST1, ST2) is transferred to the terminal equipment (11) by the terminal equipment (11) and/or its user.

6. Method according to claim 1, characterised in that the content (19.1*) provided with an identifier (ST1, ST2) is determined according to the file size of the content (19.1*).

7. Method according to claim 6, characterised in that the content (19.1*) provided with an identifier (ST1, ST2) may include, for example, resource data.

8. Method according to claim 1, characterised in that in the method
the existence is identified of content (19.1*) stored in the terminal equipment (11) and provided with a special identifier (ST1, ST2),
the need for updating of the said content (19.1*) is determined, and
if the condition criterion established for the said need for updating is fulfilled, the said content (19.1*) is transferred from the server (12) to the terminal equipment (11).

9. Method according to claim 1, characterised in that, in addition, the said terminal equipment (11) is identified in the method.

10. Method according to claim 1, characterised in that in the method
in the content (19.1*) requested by the terminal equipment (11) at least one content element is identified, which is provided with the said special identifier (ST1, ST2) and which may be, for example, a link reference and/or any resource file connected thereto, and
essentially based on the said identification, the said content (19.1*) is transferred to the terminal equipment (11).

11. Method according to claim 1, characterised in that at least a part of the content (19.1*) provided with the said identifier (ST1, ST2) is transferred encrypted.

12. Method according to claim 1, characterised in that at least a part of the content (19.1*) provided with the said identifier (ST1, ST2) is transferred compressed.

13. Method according to claim 2, characterised in that in the said background processing a specific QoS (Quality of Service) is requested of the data communication network (10).

14. Method according to claim 2, characterised in that the said data transfer performed as background processing is given priority into connection with the other functions of the terminal equipment (11).

15. System in a wireless data communication network (10) for transferring content (19.1) to terminal equipment (11), wherein to the data communication network (10) are connected at least one server (12, 13) and at least one piece of terminal equipment (11) and wherein in connection with at least one server (12) content (19.1) is arranged for transfer through the data communication network (10) as data transfer in a browser session to the terminal equipment (11), and which terminal equipment (11) includes a browser functionality (14) for processing the said content (19.1) and wherein at least one special identifier (ST1) is connected to at least a part of the said content (19.1*), which identifier is adapted to indicate the special character established for the content (19.1*) in question as regards manageability to be carried out with the terminal equipment (11), characterised in that the server (12, 13) arranged in the terminal equipment (11) and/or in the data communication network (10) includes functionalities (17, 13.1), which are adapted to manage the said content (16.1*, 19.1*) provided with the special identifier (ST1) and to carry out at least a part of the data transfer relating to the said content (16.1*, 19.1*) as background processing essentially without affecting the data transfer of the browser session proper of the terminal equipment (11).

16. System according to claim 15, characterised in that in the terminal equipment (11) an own data transfer channel (22) is fitted for the data transfer to be carried out as background processing, and wherein the said data transfer is adapted to be carried out essentially in its own connection context.

17. System according to claim 15, characterised in that the terminal equipment (11) and server (12, 13) include functionalities for encrypted transfer of at least a part of the content (19.1*) provided with the said identifier (ST1, ST2).

18. System according to claim 15, characterised in that the terminal equipment (11) and server (12, 13) include functionalities for compressed transfer of at least a part of the content (19.1*) provided with the said identifier (ST1, ST2).

19. System according to claim 15, characterised in that in connection with the terminal equipment (11) and/or the data communication network (10) there is a functionality (17, 13.1), which is adapted to identify at least one content reference of the content (19.1) to be transferred or intended for transfer to the terminal equipment (11), whereby of the content (19.1) defined directly or indirectly by the content reference at least a part is transferred to the terminal equipment (11) in consequence of the said identification.

20. Terminal equipment (11) in a wireless data communication network (10), wherein are arranged data transfer devices (18) for carrying out data transfer in the data communication network and browser devices (14) for transferring and browsing content (19.1) arranged in the data communication network (10) at the terminal equipment (11) in a browser session, and wherein at least a part of the said content (19.1*) is associated with at least one special identifier (ST1) adapted to indicate the special character of the content (19.1*) in question as regards manageability of the content (19.1*) by the browser devices (14), characterised in that in the terminal equipment (11) is also arranged a browser-independent functionality (17) adapted to manage the said content (19.1*) provided with a special identifier (ST1) and to carry out updating steps when the established criterion condition is fulfilled on at least a part of the said content (19.1*) provided with a special identifier (ST1) as background processing essentially without affecting the data transfer of the terminal equipment's (11)browser session proper.

21. Terminal equipment according to claim 20, characterised in that in the terminal equipment (11) is fitted an own data transfer channel (22) for the data transfer carried out as background processing, and wherein the said data transfer is adapted for performance essentially in its own connection context.

22. Server (12, 13) in a wireless data communication network (10) for management of content (19) to be transferred to terminal equipment (11), wherein the data communication network (10) includes one or more servers (12, 13), of which at least for some servers (12) content (19.1) is arranged intended for the terminal equipment (11) and wherein at least a part of the said content (19.1*) is associated with at least one special identifier (ST1), which is adapted to indicate the special character of the content (19.1*) in question when it is being transferred to the terminal equipment (11), characterised in that at least one of the said servers (13) includes a functionality (17), which is adapted to manage the said content (19.1*) provided with a special identifier (ST) and upon fulfilment of a criterion condition established for the terminal equipment (11) to carry out updating steps on at least a part of the said content (19.1*) as background processing essentially without affecting the data transfer of the terminal equipment's (11) browser session proper.

23. Browser equipment (14) for browsing content (19.1) at terminal equipment(11) arranged in a wireless data communication network (10), wherein the data communication network (10) includes one or more servers (12, 13), of which for at least some of the servers (12) content (19.1) is arranged intended for the terminal equipment (11) and wherein at least a part of the said content (19.1*) is associated with at least one special identifier (ST1), which is adapted to indicate the special character of the content (19.1*) in question when it is being transferred to the terminal equipment (11), characterised in that in connection with the browser equipment (14) a functionality (17) is arranged, which is adapted to manage in an established manner the said content (19.1*) provided with a special identifier (ST1) and when the established criterion condition is fulfilled to carry out updating steps on at least a part of the said content (19.1*) as background processing essentially without affecting the data transfer of the terminal equipment's (11) browser session proper.
